(19) United States
(12) Patent Application Publication
(10) Pub. No.: US 2026/0310762 A1
(43) Pub. Date: Oct. 8, 2026

(54) DETERMINING PROVENANCE OF COLLECTIBLE OBJECTS

(71) Applicant: WIZARDS OF THE COAST LLC, Renton, WA (US)

(72) Inventors: Adrian Mesa, Menifee, CA (US); Elizabeth Weeks, Renton, WA (US); David Stevens, Newcastle, WA (US); Joel Emans, Renton, WA (US); Benjamin Hankin Bleiweiss, Covington, WA (US)

(21) Appl. No.: 19/640,320

(22) Filed: Apr. 6, 2026

Related U.S. Application Data
(60) Provisional application No. 63/784,922, filed on Apr. 7, 2025.

(51) Int. Cl. G06F 21/16; G06V 20/64

(52) U.S. Cl. CPC G06F 21/16; G06V 20/64

(57) ABSTRACT

Systems and methods are provided herein for determining the provenance of objects (e.g., trading cards within tournament card decks of a trading card game). The method includes receiving a plurality of objects (e.g., collectible playing cards associated with gameplay at a tournament event). A predefined portion (e.g., a substrate or printed ink) of each object is scanned (e.g., during the tournament event or during a trade) to determine a respective digital fingerprint. The digital fingerprints are linked between a subset of objects (e.g., cards associated with a common card deck, cards within the same trade) to generate an authenticated object set. The object set is registered in a database. The authenticated object set can be associated with supplemental information such as media content, tournament history, and so forth.

### CROSS-REFERENCE TO RELATED APPLICATION(S)

The present application claims the benefit of U.S. Provisional Patent Application No. 63/784,922 entitled “DETERMINING PROVENANCE OF COLLECTIBLE OBJECTS” and filed Apr. 7, 2025. The content of the foregoing application is incorporated herein by reference in their entirety.

### INCORPORATION BY REFERENCE

The present application refers to the disclosures of U.S. Patent Application No. 2024/0296695, entitled “IRREVERSIBLE DIGITAL FINGERPRINTS FOR PRESERVING OBJECT SECURITY,” filed May 13, 2024; U.S. Patent Application No. 2022/0157038, entitled “AUTOMATED AUTHENTICATION REGION LOCALIZATION AND CAPTURE,” filed Jan. 31, 2022; European Publication No. 3,968,189, entitled “SYSTEM FOR AUTHENTICATING PHYSICAL OBJECTS USING DIGITAL FINGERPRINTS,” filed Sep. 15, 2021; U.S. Patent No. 11,250,286, entitled “AUTOMATED AUTHENTICATION REGION LOCALIZATION AND CAPTURE,” filed May 4, 2020; U.S. Patent Application No. 2020/0257791, entitled “REGIONALIZED CHANGE DETECTION USING DIGITAL FINGERPRINTS,” filed Feb. 5, 2020; U.S. Patent No. 10,614,302, entitled “CONTROLLED AUTHENTICATION OF PHYSICAL OBJECTS,” filed May 19, 2017; U.S. Patent No. 10,614,302, entitled “CONTROLLED AUTHENTICATION OF PHYSICAL OBJECTS,” filed May 19, 2017; U.S. Patent No. 10,621,594, entitled “MULTI-LEVEL AUTHENTICATION,” filed Feb. 17, 2017; U.S. Patent No. 10,192,140, entitled “DATABASE FOR DETECTING COUNTERFEIT ITEMS USING DIGITAL FINGERPRINT RECORDS,” filed Jul. 12, 2016; U.S. Patent No. 9,646,206, entitled “OBJECT IDENTIFICATION AND INVENTORY MANAGEMENT,” filed Aug. 31, 2015; European Publication No. 2,869,241, entitled “DIGITAL FINGERPRINTING TRACK & TRACE SYSTEM,” filed Nov. 3, 2014; and U.S. Patent No. 9,152,862, entitled “OBJECT IDENTIFICATION AND INVENTORY MANAGEMENT,” filed Sep. 14, 2012, each of which is incorporated by reference herein in its entirety.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

### BACKGROUND

A collectible object is an item that holds value due to its rarity, historical significance, or unique attributes, often sought after by enthusiasts and collectors. Collectible objects, such as trading cards, derive their market value from various factors, including their provenance, which refers to the history and origin of an object (e.g., contextual events associated with the object). The value of a collectible object extends beyond just the physical object itself but rather considers nonphysical contextual factors such as tournament placement records, transaction histories, documented ownership transfers, and so forth. For example, trading cards used in tournament events gain particular historical significance that impacts their market position. However, the provenance of a collectible object often includes transactions and/or events that are oftentimes associated with other, unrelated collectible objects.

### BRIEF DESCRIPTION OF THE DRAWINGS

FIG. 1 is a block diagram illustrating an example environment of an object provenance platform.

FIG. 2 is a block diagram illustrating an example environment of a digital fingerprint of a collectible card that is generated using the object provenance platform of FIG. 1.

FIG. 3 is a block diagram illustrating an example environment of linking digital fingerprints using the object provenance platform of FIG. 1.

FIGS. 4A and 4B are screenshots illustrating collectible cards linked to different object classes.

FIG. 5 is a flow diagram illustrating a process for determining provenance of tournament card decks of a trading card game using the object provenance platform of FIG. 1.

FIG. 6 is a flow diagram illustrating a process for determining provenance of trading cards during trading card transactions using the object provenance platform of FIG. 1.

FIG. 7 is a flow diagram illustrating a process for determining provenance of trading cards at a point of manufacture using the object provenance platform of FIG. 1.

FIG. 8 is a block diagram of an exemplary computing system.

FIG. 9 is a block diagram illustrating an example artificial intelligence (AI) system, in accordance with one or more embodiments.

### DETAILED DESCRIPTION

Collectible or trading cards are a well-known method of disbursing and collecting items of interest, such as game elements or public figures. Many trading cards are not only collected for their economic and historical value but are also actively used in gameplay. A trading card game is a type of game that combines strategic gameplay with the collection and trading of cards. Each card in a trading card game represents a specific game element, such as a creature, spell, item, and so forth, and has a set of attributes and abilities that influence the game’s outcome in accordance with restrictive rules of play. Players are enabled to build customized decks from their card collections and compete against each other by strategically playing their cards according to the game’s rules. The value of the cards in a trading card game can vary based on their rarity, power, and historical significance.

Collectible trading card games (e.g., trading card games, collectible card games), such as those described in U.S. Patent No. 5,622,332 and RE37,957, typically include setting players on opposing teams in a battle of strategic skill. Commercial examples of such games include Magic: The Gathering (“MTG”), Pokemon, Star Wars: Unlimited, Yu-Gi-Oh!, Lorcana, Dragon Ball Super Collectible Card Game, and Digimon Card Game. Collectible trading card games have a collectability element, which includes, for example, the ability to purchase additional game pieces/cards that each have levels of rarity from common, uncommon, and rare cards/game pieces. Each of the various collectible trading card games includes different features. For example, MTG allows a player to use multiple copies of a particular cards such as “Llanowar Elves” to increase their mana production, thereby increasing their ability to cast more powerful spells and summon stronger creatures. Other games employ the use of scratch-off surfaces to reveal underlying numbers, clips to track points on a card, tokens to be placed on top of cards, and so forth.

Trading cards, including those used in games such as MTG, are typically exchanged among enthusiasts to obtain cards needed to complete a set or to collect rare and valuable cards. Collectors buy and sell these cards for their economic and historical value, with the cards themselves having varied monetary values depending on factors such as popularity and availability of each card. Such cards are typically sold through retail game stores and other specialty outlets. The market value for trading cards is typically influenced by the provenance of the cards. For example, trading cards used in tournament events or owned by notable figures tend to gain particular historical significance that impacts their market position.

Conventional systems for authenticating trading cards typically rely on manual documentation and physical inspection. For example, collectors and experts verify the authenticity and history of each card through visual examination and reference to historical records. Further, while some conventional systems attempt to authenticate objects by, for example, creating a digital fingerprint based on physical characteristics (e.g., shape), conventional systems authenticate cards on a standalone basis, meaning each card is verified individually without considering its historical context or relationships with other cards. Conventional systems rely on manual processes to capture the contextual provenance of a card (e.g., connections and associations between different cards in which the cards were used or transacted). For example, certificates of authentication or sworn statements are often manually generated to document the provenance of the card, the process of which is both time-consuming and susceptible to human error, especially with large volumes of cards (e.g., at a tournament event).

In addition, conventional approaches to determining the provenance of trading cards were limited by scalability and computational efficiency challenges. For example, at a tournament event where thousands of cards are authenticated in a short period of time, separate distributed systems are typically used to manage contextual features of the different cards (e.g., which cards are in which card decks). To determine a particular contextual event within the provenance of a card, the data from the distributed systems are repeatedly queried manually, which wastes computational resources (e.g., computer memory, I/O operations). The repeated querying leads to increased latency and thus is not feasible during a tournament or trade in real time. Consequently, conventional systems struggle to capture a provenance record for large-scale requests.

The present system (hereinafter “object provenance platform”) addresses these challenges by determining the provenance of objects (e.g., trading cards within tournament card decks of a trading card game) while reducing need for separate distributed systems. The object provenance platform receives a plurality of objects (e.g., collectible playing cards associated with gameplay at a tournament event). A predefined portion (e.g., a substrate, printed ink) of each object is scanned (e.g., during the tournament event or during a trade) to determine a respective digital fingerprint.

The digital fingerprints are unique digital representations of each card and are determined using physical characteristics such as print patterns, textures, and/or imperfections. For example, in some embodiments, the digital fingerprint includes one or more feature vectors. Randomly-occurring and/or naturally-occurring physical features (or features that occur as a side effect of the manufacturing process) on an object are converted into a feature vector. The features are microscopic in scale or are visible to the naked eye. Such features include, for example, cracks in surface material, a crystalline pattern, a pattern of fibers, a bleed pattern, a pattern of fabrication/print irregularities, a label (e.g., sticker) attached to the object, and so forth. The features include fingerprint features from which values are derived and stored in a feature vector. The feature vector is then associated with the object and stored in a database until the object is later presented for authentication. At that point, a new digital fingerprint is extracted and compared with the digital fingerprint(s) in the database. When a sufficient match is found, the item is considered authenticated.

In some embodiments, the object provenance platform 104 determines whether a trading card is authentic by identifying an observed print pattern within a predefined region of the trading card and comparing the observed print pattern against a reference print pattern corresponding to the predefined region. For example, trading cards such as MTG cards are commonly authenticated using visual tests that examine print characteristics resulting from the manufacturing process. One such test, known as the Green-Dot test, involves examining a green dot within a logo portion of the card under magnification to identify a rosette pattern characteristic of genuine cards. Counterfeit cards often display a solid dot or irregular pattern in this region. The predefined region can include, for example, a logo portion, a set indicator, or another region of the card that exhibits characteristic print patterns. By comparing the observed print pattern against the reference print pattern indicative of an authenticated trading card, the object provenance platform 104 is enabled to determine whether the trading card is an authentic product prior to or in conjunction with generating the digital fingerprint for the trading card. Other visual authenticity tests, such as examining card stock thickness, light transmission characteristics, and/or color saturation, can similarly be performed by the object provenance platform 104 to verify authenticity.

The digital fingerprints are linked between a subset of objects (e.g., cards associated with a common card deck, cards within the same trade) to generate an authenticated object set. The object set is registered in a database. The database can be subsequently queried to return information about the history and authenticity of each card. The authenticated object set can be associated with supplemental information such as media content (e.g., images, videos), tournament history (e.g., event participation, player achievements), and so forth.

The object provenance platform addresses the challenges of conventional systems by generating digital fingerprints that include a card history within the provenance record, thereby reducing the need for separate distributed systems and computational overhead. The card history refers to a record indicating a card's involvement in one or more contextual events associated with one or more other cards (e.g., as opposed to a simply a scanning history, which logs the dates and times when an object was scanned). The card history includes contextual data such as the tournaments in which the card was used, the outcomes of those tournaments, and/or the transactions the card was involved in, such as trades between collectors.

In some embodiments, the card history is established through contextual events recorded by the system operating in different modes, such as a tournament mode, a trade mode, a print mode, and so forth, that is adjusted to construct prompts in accordance with the desired type of card history. In a tournament setting, for example, the object provenance platform is enabled to, during the tournament, receive collectible playing cards, scan predefined portions of each card to generate unique digital fingerprints, and link the digital fingerprints to establish connections (e.g., common deck name, common tournament event, common player) between cards used in the same deck. The object provenance platform stores and retrieves provenance data without repeated manual queries. As a result, the object provenance platform is enabled to quickly determine which cards were part of, for example, a winning deck.

Similarly, during a trade, the object provenance platform is enabled to scan and authenticate cards contemporaneously with the trade, link their digital fingerprints to document the transaction (e.g., parties involved, the cards exchanged), and update the provenance records during the trade. Captured provenance information is thus readily available, even during high-volume events. In print mode, the provenance is established by linking the digital fingerprint of the card with, for example, the date and location of printing, the print run, unique identifiers associated with the card's production, and so forth.

In some embodiments, the object provenance platform 104 operates using a multi-camera system to document authenticity at the point of manufacture. A first camera is positioned to capture visual data of each collectible object as the objects are produced. Upon identifying a particular collectible object, the first camera triggers a second camera to capture additional visual data, such as the collectible object entering packaging. The captured visual data from both cameras is associated with the digital fingerprint of the collectible object to generate an authenticated manufacture record.

While some embodiments of the present object provenance platform are described in detail for use with trading cards (e.g., MTG cards), the system and method disclosed herein may find application in various domains beyond trading cards. The principles and functionalities disclosed can be adapted for determining provenance in other contexts, including memorabilia, antiques, art, collectible coins, stamps, artifacts, and any other environments where provenance is prevalent. The examples provided in this paragraph are intended as illustrative and are not limiting. Any other type of provenance determination process referenced in this document and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description that references the accompanying figures follows. The scope of the invention is limited only by the claims, and the invention encompasses numerous alternatives, modifications, and equivalents. Numerous specific details are set forth in the following description in order to provide a thorough understanding of the disclosure. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

### Example Embodiments of the Object Provenance Platform

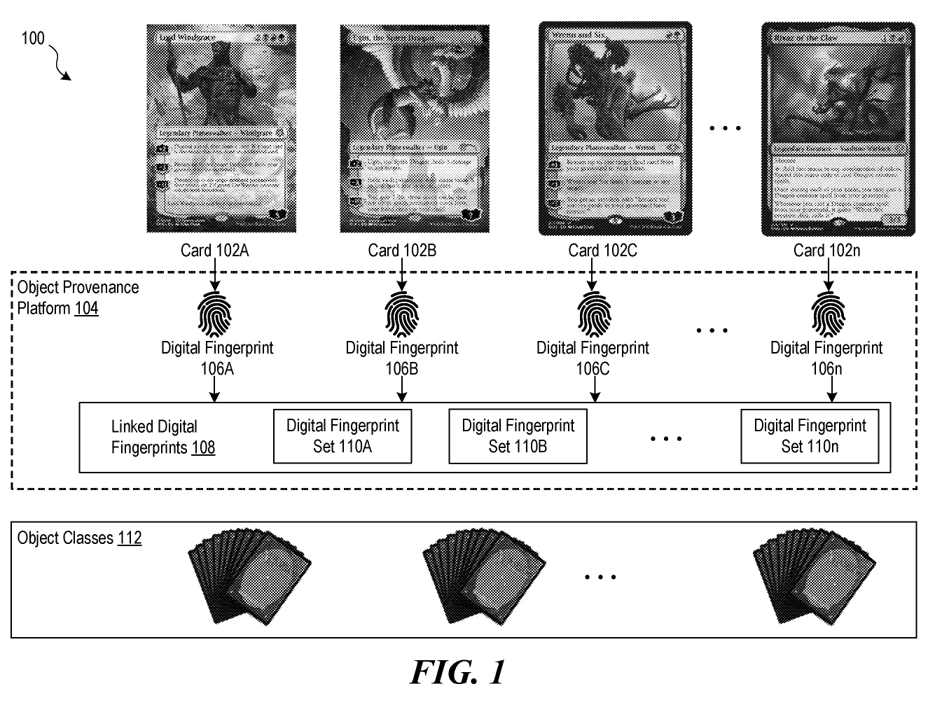

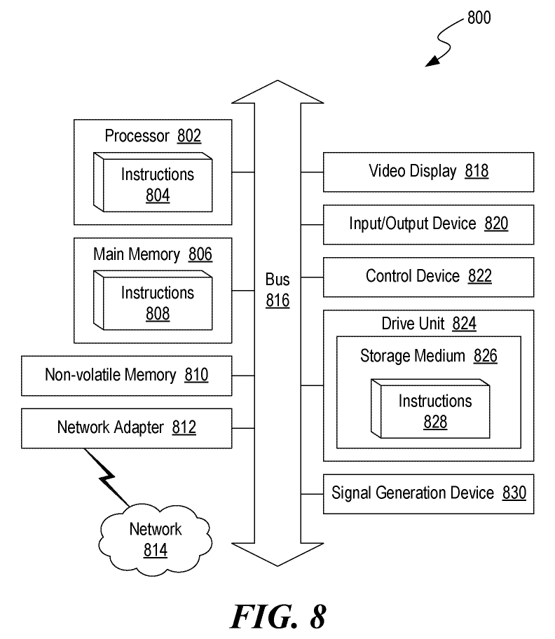

FIG. 1 is a block diagram illustrating an example environment 100 of determining provenance of cards 102 using an object provenance platform 104. Environment 100 includes the cards 102, the object provenance platform 104, digital fingerprints 106, linked digital fingerprints 108, digital fingerprint sets 110, and object classes 112. In some embodiments, the object provenance platform 104 includes components of example computer system 800 illustrated and described in more detail with reference to FIG. 8. Embodiments of the environment 100 can include different and/or additional components or can be connected in different ways.

The cards 102 (e.g., a first card 102A, a second card 102B, a third card 102C, and so forth) within environment 100 are collectible trading cards (e.g., associated with a trading card game such as MTG). The cards 102 are visually distinct and include specific game-related information, such as the identity of a subject (e.g., a creature or an artifact), in-game properties of the cards 102, and/or abilities used in gameplay. For instance, the identity of the first card 102A is “Lord Windgrace,” the identity of the second card 102B is “Ugin, the Spirit Dragon,” and the identity of the third card 102C is “Wrenn and Six.” In some embodiments, the cards 102 include collectible cards not used for gameplay, such as sports cards or entertainment memorabilia.

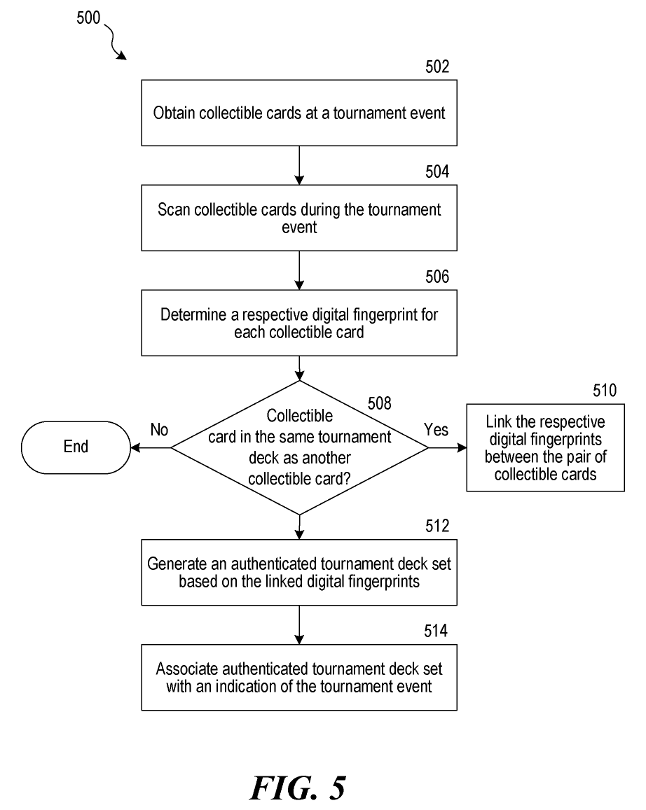

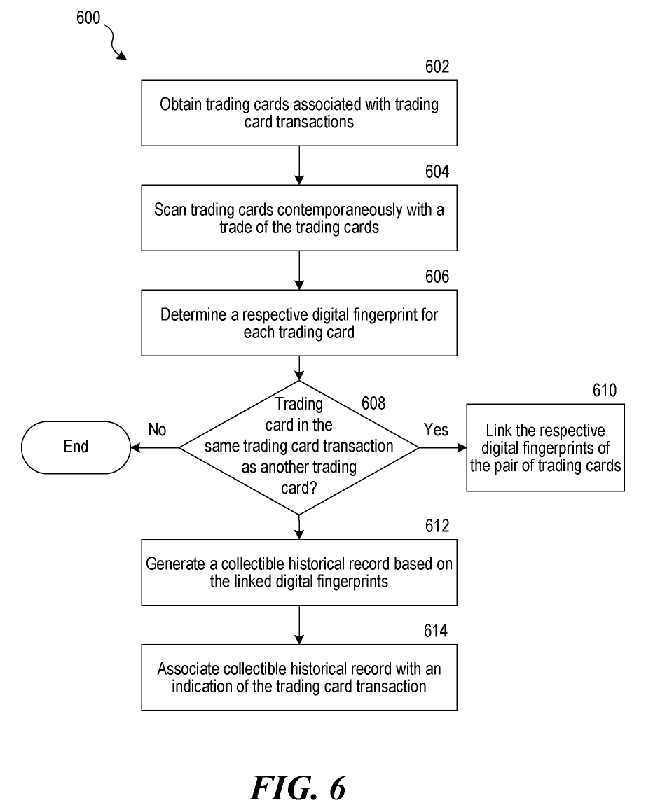

Upon scanning the cards by a card scanning apparatus (e.g., at a tournament event or during a card trade), the object provenance platform 104 generates unique digital fingerprints 106 that operate as identifiers for the cards 102 to capture the features and attributes of each individual card. The digital fingerprints 106 (e.g., a first digital fingerprint 106A, a second digital fingerprint 106B, a third digital fingerprint 106C, and so forth) are unique digital representations (e.g., a series of feature vectors, hash codes, or binary patterns) of each physical card of cards 102. The features and attributes captured by the digital fingerprints 106 can include, for example, physical characteristics of the cards, such as print patterns and textures. Methods of generating the digital fingerprints 106 of the cards 102 are further discussed with reference to FIGS. 5 and 6.

The object provenance platform 104 generates linked digital fingerprints 108 into digital fingerprint sets 110 using object classes 112 to establish connections between individual digital fingerprints, effectively mapping relationships between different cards of cards 102. The object classes 112 refer to a group of particular classifications or groupings of the cards 102 based on shared characteristics or contexts in which they were used or transacted. Object classes 112 categorize groups of collectible cards based on defined criteria, such as involvement in specific events, transactions, or thematic collections, to link together seemingly unrelated cards. The object classes 112 include, for example, cards that are within a tournament deck at a tournament event, cards being traded, specific thematic collections (e.g., a set of cards from a particular expansion), subsets of a larger collection (e.g., all foil cards from a particular MTG set), and so forth.

For example, if a user were categorizing matching objects (e.g., cards) that share a common attribute (e.g., being an MTG card) and identifying each respective object, the user would identify the cards as the same object due to the common attribute. In this context, the term “seemingly unrelated cards” refers to cards that, while all being cards sharing a common attribute (e.g., all MTG cards), are different from each other and are easily identified as such (e.g., identifying between specific MTG cards such as “Lord Windgrace” and “Wrenn and Six”).

Using the object classes 112, the object provenance platform 104 is enabled to associate the digital fingerprints 106 into separate digital fingerprint sets 110. The object provenance platform 104 relates the digital fingerprints of different cards that do not have a predefined relationship. The newly created relationship forms the object classes 112. For example, a deck list is an object class that links together the digital fingerprints of various cards used in the same deck, even though these cards are different and do not have an inherent relationship. By creating these new relationships, the object provenance platform categorizes, and links cards based on their usage in specific contexts, such as being part of a tournament deck, being involved in a particular trade, belonging to a thematic collection, and so forth.

The digital fingerprint sets 110 (e.g., a first digital fingerprint set 110A, a second digital fingerprint set 110B, and so forth) are a collection of digital fingerprints from digital fingerprints 106 that are linked together based on their association with a particular object class of object classes 112. For example, each digital fingerprint set of the digital fingerprint sets 110 represents cards played within a common tournament deck. In some embodiments, a digital fingerprint can be mapped to multiple digital fingerprint sets. Generating the linked digital fingerprints 108 increases the historical and collectible value of the cards 102 and creates a verifiable provenance record that can later be used to authenticate the cards 102. Methods of generating the linked digital fingerprints 108 are further discussed with reference to FIGS. 5 and 6.

In one example, in a tournament setting, the object provenance platform 104 generates digital fingerprints for each card used during the tournament event. The digital fingerprints are linked together to form a digital fingerprint set 110, representing the entire tournament deck. This association indicates that the cards were part of the same deck used in a specific tournament, thereby establishing a verifiable link between them. If, for example, a player achieved a prestigious placement in the tournament, the digital fingerprint set 110 is enabled to document the contextual event by linking together the seemingly unrelated cards of the deck used by the player, improving the collectability of the card. Collectors can subsequently trace the exact cards that contributed to the tournament results.

In another example, in a trading scenario, the object provenance platform 104 scans and generates digital fingerprints for each card involved in the trade. The digital fingerprints are linked to form a digital fingerprint set 110, representing the transaction. This link indicates the authenticity of the traded cards and records their transfer of ownership. For example, when two collectors trade rare, seemingly unrelated cards, the linked digital fingerprints create a verifiable record of the transaction. The provenance record provides future buyers and collectors with documented proof of the cards’ history and authenticity, thereby increasing their collectible value.

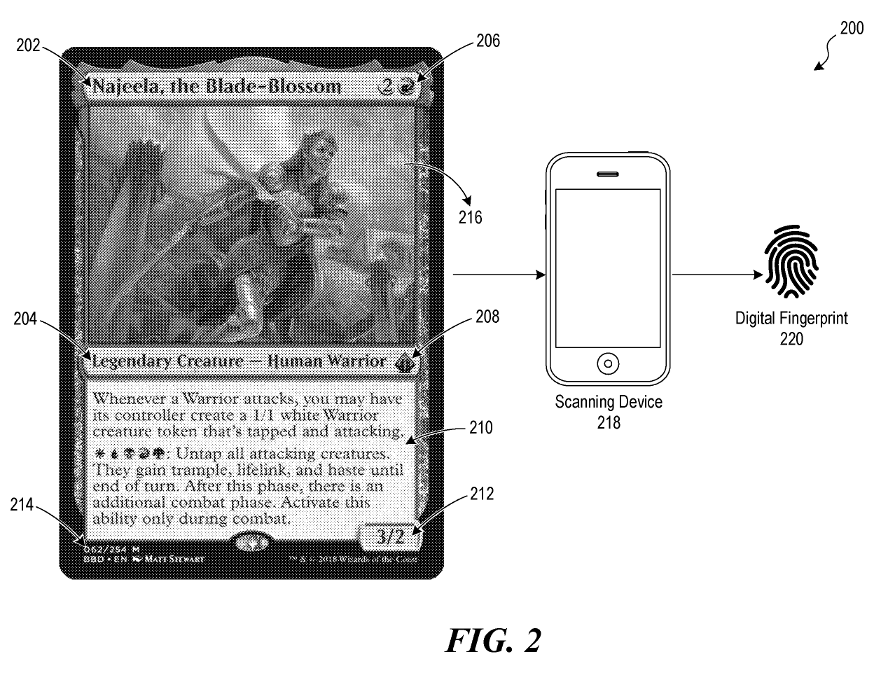

FIG. 2 is a block diagram illustrating an example environment 200 of a digital fingerprint (e.g., the digital fingerprints 106) of a collectible card (e.g., the cards 102) that is generated using the object provenance platform 104 of FIG. 1. Embodiments of the environment 200 can include different and/or additional components or can be connected in different ways.

The collectible card within the environment 200 includes visual identifiers such as a nameplate 202, a type 204, a resource cost 206, a set indicator 208, a text box 210, a statistics indicator 212, a collector number 214, an artwork portion 216, and so forth. The nameplate 202 on the collectible card identifies a name of the collectible card (e.g., “Najeela, the Blade-Blossom” in FIG. 2). The type 204 specifies a category and/or subcategory of the collectible card and is used to classify the card within gameplay. For example, “Legendary Creature – Human Warrior” indicates both a primary type as a creature and a subtype of a Human Warrior, which determine how the card functions within the game. Examples of other types include, for example, “Artifact – Equipment” or “Sorcery,” each representing different aspects of gameplay mechanics and card roles. For example, cards of a particular primary type are subject to a particular set of game rules, whereas cards of a particular subtype are subject to a different set of game rules.

The resource cost 206 refers to a game mechanic element that requires the playing of at least one card or other game piece before other cards/game pieces are played. In other words, a player must play one or more cards/game pieces having a total number of points (or other attributes, such as colors or combination of colors, or have the appropriate number of symbols) before another type of card/game piece is played. The resource cost 206 can indicate an in-game resource (e.g., mana) required to play the card and is visually represented by symbols on the card (e.g., the resource cost 206 in FIG. 2 representing two generic mana and one red mana). The set indicator 208 denotes the specific set to which the card belongs, such as “BBD-EN” for Battlebond in English. The set indicator 208 enables collectors and players to identify the card’s origin and differentiate the card from similar cards across various sets. The text box 210 on the card includes descriptions of the card’s abilities and/or effects that define how the card performs during gameplay.

The statistics indicator 212 quantifies the card’s in-game statistics (e.g., power, toughness), shown as “3/2” in FIG. 2, three power and two toughness, and determines the card’s effectiveness in battles within the game. The collector number 214 provides a unique sequence identifier within its set, like “062/254,” to categorize the card’s position among all cards in the set. The artwork portion 216 displays a graphical portion of the card (e.g., a depiction of the subject identified by the nameplate 202). Particular features or combinations of features of the collectible card often influence the card’s visual appeal and collectible value.

The environment 200 further includes a scanning device 218 and a digital fingerprint 220. In some embodiments, the scanning device 218 includes components of example computer system 800 illustrated and described in more detail with reference to FIG. 8. In some embodiments, the scanning device 218 (e.g., a smartphone) captures an image of the collectible card and uses the above-described portions of the card to generate the digital fingerprint 220 while not physically tampering with the card. The digital fingerprint 220 uniquely identifies the collectible card and associates the above-described portions of the card in the form of a digital identifier. In some embodiments, the scanning device 218 includes a camera system connected to a computing device (e.g., a laptop) for capturing images or other visual data of collectible objects. The authenticated records generated by the object provenance platform 104 are subsequently accessible via the same or different computing device (e.g., a smartphone) by scanning the collectible object.

To generate the digital fingerprint 220 from the image of the card, the object provenance platform 104 identifies, from the image, one or more of the above-described portions of the card. For example, the object provenance platform 104 captures physical features such as serial numbers, print patterns, and/or manufacturing variances on particular portions that uniquely identify the card. In some embodiments, the scanning device 218 prioritizes one or more portions of the card over another portion. For example, the object provenance platform 104 weighs specific areas, such as the nameplate 202, more than other areas, such as the artwork portion 216. Methods of prioritizing different portions of the card are discussed with further reference to FIGS. 5 and 6.

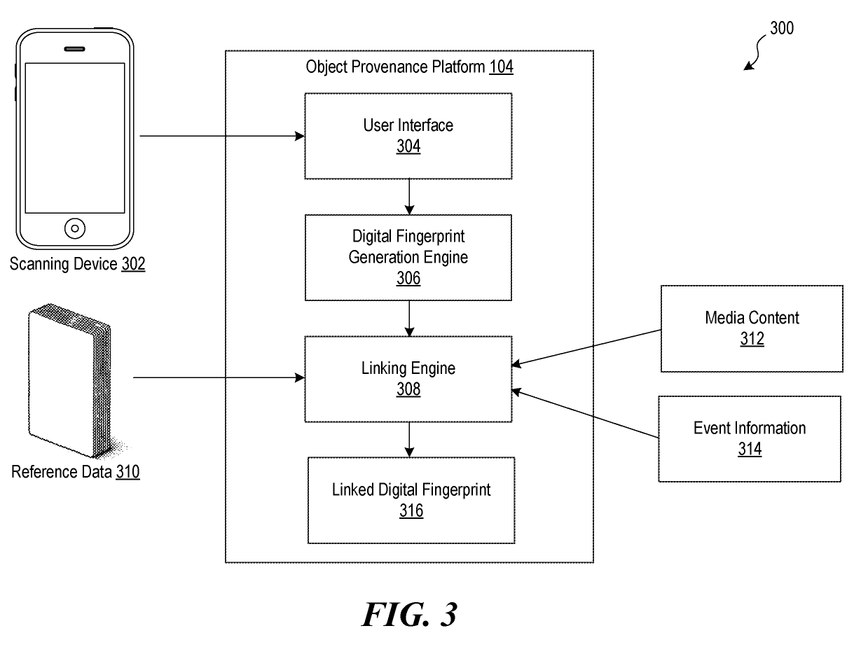

FIG. 3 is a block diagram illustrating an example environment 300 of linking digital fingerprints using the object provenance platform 104 of FIG. 1. The environment 300 includes a scanning device 302, a user interface 304, a digital fingerprint generation engine 306, a linking engine 308, reference data 310, media content 312, event information 314, and a linked digital fingerprint 316. Embodiments of the environment 300 can include different and/or additional components or can be connected in different ways.

The scanning device 302 is the same as or similar to the scanning device 218 referenced in FIG. 2. Images captured by the scanning device 302 are received by the user interface 304. Through the user interface 304, users are enabled to initiate scans of collectible cards, view the provenance of the cards, and so forth. In some embodiments, the user interface 304 enables users to upload images captured by the scanning device 302. The user interface 304 enables, in some embodiments, the users to select the type of relationship (e.g., link) being created between the digital fingerprints, such as trade, deck list, celebrity signature, and so forth. For example, if a card was part of a trade, the user is enabled to specify the relationship (i.e., a trade) and/or information associated with the relationship (e.g., the parties involved, the date of the trade transaction, the value of the trade transaction, and so forth).

The digital fingerprint generation engine 306 generates digital fingerprints (e.g., digital fingerprints 106 in FIG. 1) of the cards corresponding to the images captured by the scanning device 302. The digital fingerprint generation engine 306 uses portions of the card discussed in FIG. 2, along with physical anomalies or marks, to generate the digital representation.

The linking engine 308 uses the digital fingerprints generated by the digital fingerprint generation engine 306 to link the digital fingerprints with additional data to determine a provenance record of the card. The data includes, for example, reference data 310, media content 312, event information 314, and so forth. The linking engine 308 associates each digital fingerprint with the corresponding contextual events to generate the provenance record.

The reference data 310 includes a database of preexisting information that the object provenance platform 104 uses to cross-reference the scanned card. For example, the reference data 310 can include information indicating the object classes 112 in FIG. 1. In some embodiments, the reference data 310 includes images and details of other cards, historical records, and other information used to determine the additional information of the card. The media content 312 includes additional multimedia information linked to the digital fingerprint. The media content 312 includes, for example, images, videos, or other forms of media related to the card. For example, the media content 312 includes video footage of the card being used in a particular event (e.g., a pro tour or high-stakes tournament). In another example, the media content includes video evidence of a signature, such as when a well-known player or celebrity is captured signing the card. Moreover, in some examples, portions of an existing video are documented as part of the media content (e.g., when the card is played in a video by a popular content creator). The media content provides proof of authenticity and increases the collectability of the card.

The event information 314 includes information associated with events related to the card, such as tournament participation, trades, ownership history, and so forth. The event information 314 ensures that the provenance record includes occurrences associated with the card that can affect the card’s authenticity and value.

The linked digital fingerprint 316 refers to a digital record that combines the unique fingerprint of the card with all associated data (e.g., reference data 310, media content 312, event information 314, and so forth). Examples of the linked digital fingerprint 316 are further discussed with reference to the linked digital fingerprints 108 in FIG. 1.

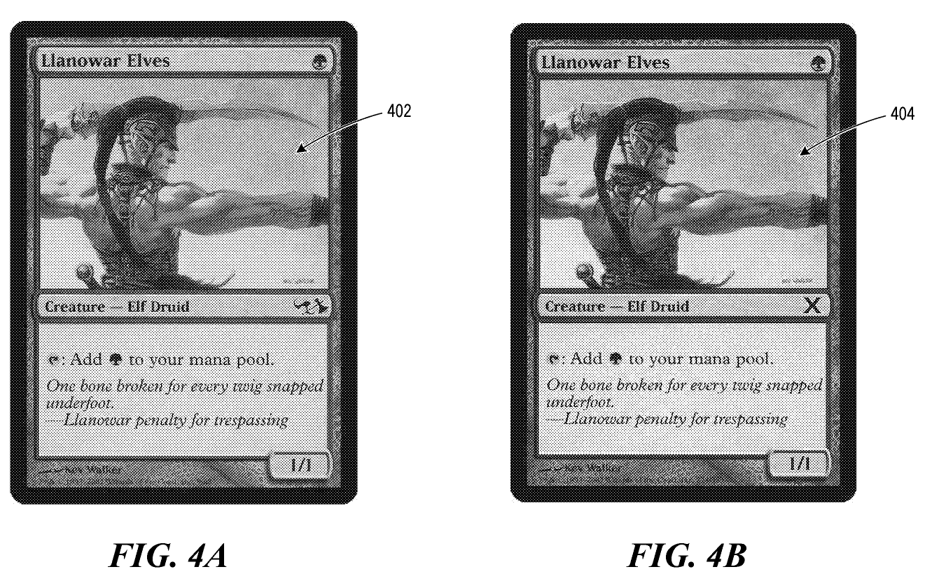

FIGS. 4A and 4B are screenshots illustrating collectible cards linked to different object classes. As the object provenance platform 104 distinguishes increasingly more cards between vector-based digital fingerprints, vector collisions become more likely. A collision occurs when two different cards are assigned the same digital fingerprint due to similarities in their physical characteristics. For example, if all cards were scanned at the time of printing, it would result in hundreds of thousands of matching cards being scanned (e.g., in this context, matching refers to cards with matching print content). The large volume increases the probability that two distinct cards are incorrectly identified as the same due to the limitations in the resolution and uniqueness of the digital fingerprints.

To reduce the chance of collisions when distinguishing between vector-based digital fingerprints, the object provenance platform 104 sorts the cards by printing, thereby reducing the overall number of cards in a matching set. FIG. 4A includes a first artwork portion 402, whereas FIG. 4B includes a second artwork portion 404. In some embodiments, the object provenance platform 104 initially sorts the cards (e.g., “Llanowar Elves” cards) using human-apparent visual indicia, such as set symbols, color saturation, card shape cut, and so forth. In some embodiments, the second artwork portion 404 features a different character pose, a varied background, and a different artistic style, distinguishing it from the first artwork portion 402. For example, the first artwork portion 404 depicts a more saturated artwork than the second artwork portion 402 despite the artwork portion featuring the same character pose and background. The human-apparent visual indicia are similarly computer vision-apparent, and those rough distinctions are evident in preliminary digital comparisons performed prior to vector-based digital fingerprint comparisons of manufacturing variance.

By sorting cards based on visual indicia initially (e.g., via computer vision), the object provenance platform 104 reduces the number of cards to be distinguished using vector-based fingerprint comparisons. The initial layer of sorting reduces the likelihood of collisions when the object provenance platform 104 scans and matches digital fingerprints.

### Example Methods of Using the Object Provenance Platform

FIG. 5 is a flow diagram illustrating a process 500 for determining provenance of tournament card decks of a trading card game using the object provenance platform 104 of FIG. 1. In some embodiments, the process 500 is performed by components of example computer systems 800 illustrated and described in more detail with reference to FIG. 8. Embodiments of the process 500 can include different and/or additional operations or can perform the operations in different orders.

In operation 502, the object provenance platform 104 obtains a plurality of collectible playing cards (e.g., associated with gameplay at a tournament event). The object provenance platform 104 obtains the cards during events such as tournaments, trades, conventions, and so forth. For example, during a tournament, the object provenance platform 104 obtains cards by collecting the cards at various stages of the event. When players register their decks, the players submit their cards to the tournament organizers. The organizers collect these cards for the purpose of, for example, documentation and/or authentication. In some embodiments, the cards are collected at the end of the tournament and are associated with one or more players reaching a particular tournament placement at the tournament event (e.g., top eight). The cards associated with players reaching particular tournament placements often gain historical significance due to their involvement in notable tournament events. For example, a card that was part of a winning deck in a major tournament may be considered more valuable and desirable to collectors.

In a trading scenario, the object provenance platform 104 obtains cards by collecting them during the trade process. When two collectors engage in a trade, the collectors present their cards to the object provenance platform 104 (or an individual managing the object provenance platform 104). Additionally, in some embodiments, the object provenance platform 104 obtains cards during conventions and/or other events where collectors gather. At the events, collectors are enabled to voluntarily submit their cards for documentation and/or authentication to create a provenance record for the cards.

Furthermore, in some embodiments, the object provenance platform 104 obtains cards directly from manufacturers. During the production process, manufacturers collect cards as they are printed in order to determine a provenance record using the object provenance platform 104 at the earliest possible stage. This is particularly useful for newly printed cards, limited edition releases, serialized cards, and so forth to register the cards’ authenticity before the cards enter the market.

In operation 504, the object provenance platform 104 scans, via a card scanning apparatus, a predefined portion of each collectible playing card of the plurality of collectible playing cards during the tournament event. The predefined portion is a specific area of the card that contains unique and identifiable features and, in some embodiments, is selected to include elements that are less likely to be altered or damaged over time. For example, a nameplate portion of the card is less likely to be altered than an artwork portion of the same card. The predefined portion can vary depending on the type of card and its unique characteristics. Features can include, for example, scratches, color, patterns, texture, and so forth.

In some embodiments, the predefined portion encompasses an image of the entire card, which is particularly useful for cards where unique features are distributed across the entire surface, such as intricate artwork or complex patterns. In other cases, the predefined portion is a specific subregion of the card. For example, the predefined portion includes nameplate, artwork, or specific security features such as holograms or microtext since the features contain unique identifiers that are difficult to replicate or alter without detection. In some embodiments, multiple regions are used to account for variations (e.g., one portion may be destroyed or otherwise unidentifiable). For instance, a card has several regions with significant variations holding greater weight (e.g., a nameplate), while other regions hold lower weight (e.g., the artwork portion). This approach is particularly useful in cases where parts of the card might be damaged or missing, as the remaining regions can still provide information.

For cards that have removable labels attached, the object provenance platform 104 scans both the label and the card itself (e.g., both the label and the substrate the label is attached to). For example, released MTG sets have included sticker sheets that players are enabled to use to modify their cards during gameplay. The sticker sheets enable players to add new abilities, alter in-game statistics (e.g., power and toughness), and/or modify other card characteristics by placing stickers on their cards. Since the stickers are removable, simply using the sticker or card itself as the authentication region is often not sufficient.

In some embodiments, the card scanning apparatus is a first card scanning apparatus and the plurality of collectible playing cards is a first plurality of collectible playing cards. The object provenance platform 104 scans, using a second card scanning apparatus, a second plurality of collectible playing cards to generate at least one additional authenticated tournament deck set during the tournament event. The second card scanning apparatus scans the second plurality of collectible playing cards in parallel to the first card scanning apparatus scanning the first plurality of collectible playing cards. Parallel scanning improves the efficiency and speed of creating provenance records, especially during large-scale events such as tournaments where numerous cards often need to be authenticated in a limited timeframe.

In operation 506, the object provenance platform 104 determines a respective digital fingerprint for each collectible playing card. The respective digital fingerprint for each collectible playing card is different. For example, in some embodiments, the digital fingerprint is a set of feature vectors, which can include an array of color or grayscale numeric values corresponding to areas within the selected region to, for example, identify locations/shapes of the predefined portion.

In some instances, users (e.g., players) are more likely to alter (e.g., paint, damage) certain portions of the cards while leaving other parts intact. For example, users often desire to customize or personalize the card without compromising the card’s overall recognizability and functionality in gameplay. In some scenarios, players paint or add artwork to the borders or edges of the card, which are less frequently used to the card's identity, while avoiding modifications to areas such as the nameplate or central artwork typically used to identify the card. As a result, the card remains identifiable after some modifications, but not others. The selective alteration creates challenges for maintaining accurate provenance records, as the modified portions of the card may no longer match the original reference points.

Thus, in some embodiments, the object provenance platform 104 prioritizes different portions of each collectible playing card for generating the digital fingerprint based on an estimated degree of alteration over time of each corresponding portion. For example, if the collectible playing card includes a nameplate portion and an artwork portion, the object provenance platform 104 identifies, by the card scanning apparatus, a set of reference points in the nameplate portion and the artwork portion of the collectible playing card.

In some embodiments, the object provenance platform 104 assigns, by the card scanning apparatus, a weight to each reference point. For instance, a greater weight is assigned to reference points located within the nameplate portion than reference points located within a corresponding artwork portion of each collectible playing card. Based on the assigned weights, the object provenance platform 104 determines the respective digital fingerprint for each collectible playing card by prioritizing (e.g., placing greater weight on) generating vectors from portions of the card that are less likely to be modified. Thus, the digital fingerprint is enabled to withstand potential alterations.

In some embodiments, the digital fingerprint indicates a particular type of each object of the plurality of object. The particular type of each object is determined, for example, based on an artwork portion of the object. For example, if the artwork portion of a card includes specific color patterns and design elements that match those of a known set, the object provenance platform 104 determines that the card belongs to that particular set. The classification is included in the digital fingerprint of the card.

The object provenance platform 104, in some embodiments, adjusts one or more reference points used to generate the digital fingerprint based on the configuration of the cards at the time of printing (e.g., when cards are cut from larger sheets). For example, when printed, cards are typically produced in sheets containing 100 or more cards at once. The sheets are then cut and subdivided into individual cards. During the division, each individual card's respective reference points may be distorted after the sheet is cut into separate cards. Thus, when generating the digital fingerprint of the cards as they are printed (e.g., by using a printer-mounted camera), the object provenance platform 104 is enabled to upscale the number of vector-based fingerprints to match the final number of individual cards. For example, if a sheet contains 121cards, the final object will represent 1/121 of the original scanned sheet. Consequently, the generated reference points in the fingerprints are adjusted to, for example, collect the same X number of reference points from each 1/121 portion of the sheet in the same areas.

In some embodiments, the object provenance platform 104 is prevented from placing reference points around the edges of the cards on the sheet, as the cutting process introduces manufacturing variance. The initial fingerprint scan accounts for the variance by using reference points on more stable and less variable areas of the card (e.g., the center). Thus, the object provenance platform 104 is enabled to maintain the accuracy and reliability of the digital fingerprints even after the cards are cut from the larger sheets, and provide a verifiable provenance record from the moment of printing through the cards’ lifecycle.

In operation 508, the object provenance platform 104 determines whether a particular collectible card is in the same tournament deck as another collectible card. If the particular collectible card is not in the same tournament deck as another collectible card, the process 500 ends. If the particular collectible card is in the same tournament deck as another collectible card, in operation 510, the object provenance platform 104 links the respective digital fingerprints between a subset of collectible playing cards associated with a common card deck of a plurality of card decks. Each card deck of the plurality of card decks is configured in accordance with a set of predefined game rules associated with the tournament event. The object provenance platform 104 links the respective digital fingerprints by, for example, indicating the linkage within the metadata of each digital fingerprint.

In some embodiments, the object provenance platform 104 uses a knowledge graph or other data structure to link the respective digital fingerprints between a subset of collectible playing cards associated with a common card deck. A knowledge graph is a structured representation of information that captures relationships between entities in a graph format, where nodes represent entities (e.g., collectible cards, tournaments, players) and edges represent the relationships between them (e.g., “part of the same deck,” “used in the same tournament”). By including metadata such as tournament information, player details, and/or deck composition into the knowledge graph, the object provenance platform 104 is enabled to query and traverse the graph to identify and link cards that share common attributes. For instance, if two cards are connected to the same tournament node and player node, the object provenance platform 104 infers that they were part of the same deck.

In operation 512, the object provenance platform 104 generates an authenticated tournament deck set. In operation 514, the object provenance platform 104 registers the authenticated tournament deck set in a database by associating the linked digital fingerprints of the subset of collectible playing cards from each card deck with an indication of the tournament event. In some embodiments, the object provenance platform 104 validates a degree of participation of a user at the common event by comparing a set of scanned digital fingerprints against the linked digital fingerprints of the subset of objects of each object class.

In some embodiments, the object provenance platform 104 obtains a digital interface including supplemental information associated with the authenticated tournament deck set. The object provenance platform 104 enables access to the digital interface subsequent to scanning at least one of the subset of collectible playing cards. The digital interface displays a visual representation of the respective card decks associated with the scanned subset of collectible playing cards.

The supplemental information includes, for example, date of event, player, the players record at the event, name of the event, name of deck (e.g., “Aristocrats,” “Cheerios,” “Eggs,” “Sligh,” “The Rock,” “Ponza,”, “Tron”, “Amulet Titan”, “Domain Overlords”, “Fog Control”, “Red Deck Wins”), the location of the event, the format of the tournament (e.g., Standard, Modern, Legacy), and any notable achievements or highlights (e.g., “Top 8 finish,” “Champion”), and so forth. For example, if a card was part of a deck named “Cheerios” used by a player who won a major tournament on a specific date, “Cheerios,” the player’s name, the tournament name, and the date are added to the digital fingerprint. The digital fingerprint links this card to other cards in the same “Cheerios” deck. The object provenance platform 104 is enabled to subsequently query to retrieve the added information, as well as information already stored within the grouping of digital fingerprints associated with one or more portions of the supplemental information, such as the deck’s performance, the player’s history, and the specific events where the deck was used.

In some embodiments, the object provenance platform 104 generates a set of media content associated with the authenticated tournament deck set. The set of media content includes, for example, video content, audio content, an indication of a trade history, an indication of a tournament history, and so forth. In some embodiments, the object provenance platform 104 obtains media content associated with at least one object of the plurality of objects. The media content includes, for example, a video of the subset of objects associated with a trade, a signature, a modification associated with the subset of objects, and so forth. The object provenance platform 104 associates the obtained media content with the respective digital fingerprint of the at least one object. In some embodiments, the media content displays a physical signing event to generate a signature portion of the at least one object.

FIG. 6 is a flow diagram illustrating a process 600 for determining provenance of trading cards during trading card transactions using the object provenance platform 104 of FIG. 1. In some embodiments, the process 600 is performed by components of example computer systems 800 illustrated and described in more detail with reference to FIG. 8. Embodiments of the process 600 can include different and/or additional operations or can perform the operations in different orders.

In operation 602, the object provenance platform 104 obtains a plurality of trading cards associated with multiple trading card transactions. The object provenance platform 104 obtains trading cards from various sources, such as individual collectors, retail stores, online marketplaces, and trading events. These cards may be part of recent transactions or historical trades that need to be authenticated and recorded.

Contemporaneously with a trade of the plurality of trading cards, in operation 604, the object provenance platform 104 scans a predefined portion of each trading card via a card scanning apparatus. Methods of scanning the predefined portion are discussed in further detail with reference to FIG. 5.

In operation 606, the object provenance platform 104 determines a respective digital fingerprint for each trading card of the plurality of trading cards. The respective digital fingerprint for each trading card is different. Methods of determining the digital fingerprints are discussed in further detail with reference to FIG. 5. In some embodiments, scanning the predefined portion prioritizes different portions of each trading card for generating the digital fingerprint based on an estimated degree of alteration over time of each corresponding portion. The different portions of each trading card include, for example, a nameplate portion indicating a name of the trading card, an artwork portion displaying visual content representative of the trading card, a symbol portion indicating a type of the trading card, a text portion indicating a set of game abilities associated with the trading card, a resource portion indicating a set of game resources used to activate the trading card, and so forth.

In operation 608, the object provenance platform 104 determines whether a particular trading card is in the same trading card transaction as another trading card. If the particular trading card is not in the same trading card transaction as another trading card, the process 600 ends. If the particular trading card is in the same trading card transaction as another trading card, based on determining the respective digital fingerprint for each trading card, in operation 610, the object provenance platform 104 links the digital fingerprints of a subset of the plurality of trading cards.

In operation 612, the object provenance platform 104 generates a collectible historical record indicating each trading card transaction of the multiple trading card transactions that a particular trading card was included in. In operation 614, the object provenance platform 104 registers the collectible historical record in a database by associating the linked digital fingerprints of the subset of trading cards from each card set with an indication of the trading card transaction.

In some embodiments, the object provenance platform 104 obtains a digital interface comprising transaction information and historical trading data associated with the collectible historical record. The object provenance platform 104 enables access to the digital interface subsequent to scanning at least one of the subsets of trading cards. The object provenance platform 104 updates the historical trading data to reflect a degree of value appreciation of at least one of the subsets of trading cards over multiple transactions.

In some embodiments, the object provenance platform 104 generates media content associated with the authenticated transaction set, wherein the media content includes a video of the particular trading card transaction depicting a physical transfer of the at least one of the subset of trading cards between a first trading entity and a second trading entity of the particular trading card transaction. The media content alternatively includes, for example, a video of the card being altered, a video of an individual signing the card, an audio file, an image, a document, and so forth.

The object provenance platform 104 stores the media content in the database, which includes, for example, previous trading entities or previous transaction values of the authenticated transaction set. In some embodiments, the object provenance platform 104 associates a respective linked digital fingerprint of at least one of the subset of trading cards from each card set with an owning user identifier that indicates one or more previous owners of the respective trading card.

In some embodiments, the object provenance platform 104 records a card condition of a particular trading card across the multiple trading card transactions. The object provenance platform 104 associates an indication of the card condition of the particular trading card with a respective digital fingerprint of the particular trading card. In some embodiments, the object provenance platform 104 generates a degree of authenticity of at least one of the subsets of trading cards based on respective digital fingerprints of the at least one of the subsets of trading cards matching a set of predefined digital fingerprints.

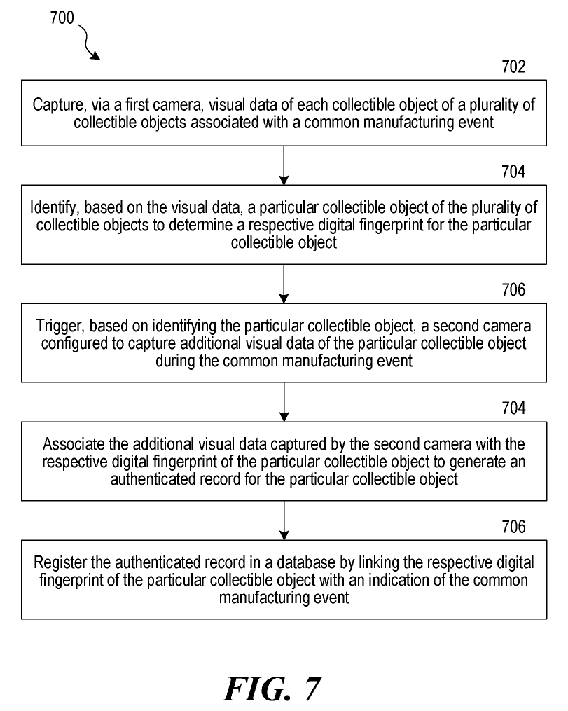

FIG. 7 is a flow diagram illustrating a process 700 for determining provenance of trading cards at a point of manufacture using the object provenance platform of FIG. 1. In some embodiments, the process 700 is performed by components of example computer systems 800 illustrated and described in more detail with reference to FIG. 8. Embodiments of the process 700 can include different and/or additional operations or can perform the operations in different orders.

In operation 702, the object provenance platform 104 captures, via a first camera, visual data of each collectible object of a plurality of collectible objects associated with a common event (e.g., a common manufacturing event, tournament, or trade). In some embodiments, the first camera is positioned overhead on a distribution line, and the visual data is captured as the plurality of collectible objects move along the distribution line. The first camera scans at least one surface (e.g., a front surface, a back surface, or both) of each collectible object as the collectible objects pass beneath the camera. In some embodiments, the first camera and a second camera are communicatively coupled to a computing device, and the computing device is configured to receive the visual data from the first camera.

In operation 704, the object provenance platform 104 identifies, based on the visual data, a particular collectible object of the plurality of collectible objects to determine a respective digital fingerprint for the particular collectible object. The respective digital fingerprint for each collectible object is different. The digital fingerprint is generated based on scanning at least one surface of the particular collectible object. In some embodiments, the object provenance platform 104 evaluates the visual data against one or more visual criterion and associates a circulation designation with the respective digital fingerprint of the particular collectible object based on whether the particular collectible object satisfies the one or more visual criterion. For example, if overprinting occurs because only the “best” (e.g., least errors) copies are desired for distribution, the object provenance platform 104 differentiates between which collectible objects should be circulated versus non-circulated. In some embodiments, the computing device appends a tag to the respective digital fingerprint of the particular collectible object, such that the tag indicates a classification of the particular collectible object (e.g., “A” for circulated, “B” for non-circulated).

In operation 706, the object provenance platform 104 triggers, based on identifying the particular collectible object, a second camera structured to capture additional visual data of the particular collectible object (e.g., during the manufacturing event, tournament, or trade). In some embodiments, the additional visual data depicts the particular collectible object in transit to packaging. In some embodiments, the computing device transmits a trigger signal to the second camera based on identifying the particular collectible object. The second camera is structured to autonomously or automatically capture the additional visual data of the particular collectible object as the particular collectible object is packaged. For example, the additional visual data captured by the second camera depicts the particular collectible object being inserted into a wrapper/packaging.

In operation 708, the object provenance platform 104 associates (e.g., links, maps) the additional visual data captured by the second camera with the respective digital fingerprint of the particular collectible object to generate an authenticated record. The authenticated record links the visual data from the first camera and the additional visual data from the second camera with the digital fingerprint, thereby documenting the collectible object's provenance through the manufacturing and packaging process.

In operation 710, the object provenance platform 104 registers the authenticated record in a database by linking the respective digital fingerprint of the particular collectible object with provenance data (e.g., an indication of the common manufacturing event, tournament, or trade) associated with the particular collectible object. The provenance data includes, for example, a date of manufacture, a location of manufacture, a print run identifier, and/or a production identifier associated with the particular collectible object.

In some embodiments, the database is further structured to store a first digital fingerprint of the particular collectible object generated prior to a modification event (e.g., an autographing event) and a second digital fingerprint of the particular collectible object generated subsequent to the modification event, such that the first digital fingerprint and the second digital fingerprint are linked to document the modification event.

In some embodiments, the provenance engine validates authenticity of the particular collectible object by comparing the respective digital fingerprint of the particular collectible object against a new digital fingerprint associated with the particular collectible object. The authenticated record is accessible via a computing (e.g., mobile) device subsequent to scanning the particular collectible object using the mobile device.

### Example Computing Platform of the Object Provenance Platform

FIG. 8 is a block diagram illustrating an example computer system 800, in accordance with one or more embodiments. In some embodiments, components of the example computer system 800 are used to implement the software platforms (e.g., the object provenance platform 104) described herein. At least some operations described herein can be implemented on the computer system 800.

The computer system 800 can include one or more central processing units (“processors”) 802, main memory 806, non-volatile memory devices 810, network adapters 812 (e.g., network interface), video displays 818, input/output devices 820, control devices 822 (e.g., keyboard and pointing devices), drive units 824 including a storage medium 826, and a signal generation device 820 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 894 bus (also referred to as “Firewire”).

The computer system 800 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 800.

While the main memory 806, non-volatile memory devices 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computer system 800. In some embodiments, the non-volatile memory devices 810 or the storage medium 826 is a non-transitory, computer-readable storage medium storing computer instructions, which can be executed by the one or more “processors” 802 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 804, 808, 828) set at various times in various memory and storage devices in a computer device. When read and executed by the one or more processors 802, the instruction(s) cause the computer system 800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical discs (e.g., compact disc read-only memory (CD-ROMS), digital versatile discs (DVDs)), and transmission-type media such as digital and analog communication links.

The network adapter 812 enables the computer system 800 to mediate data in a network 814 with an entity that is external to the computer system 800 through any communication protocol supported by the computer system 800 and the external entity. The network adapter 812 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 812 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions, including the access and operation rights of an object by an individual, a machine, and/or an application, and the circumstances under which the permission rights stand.

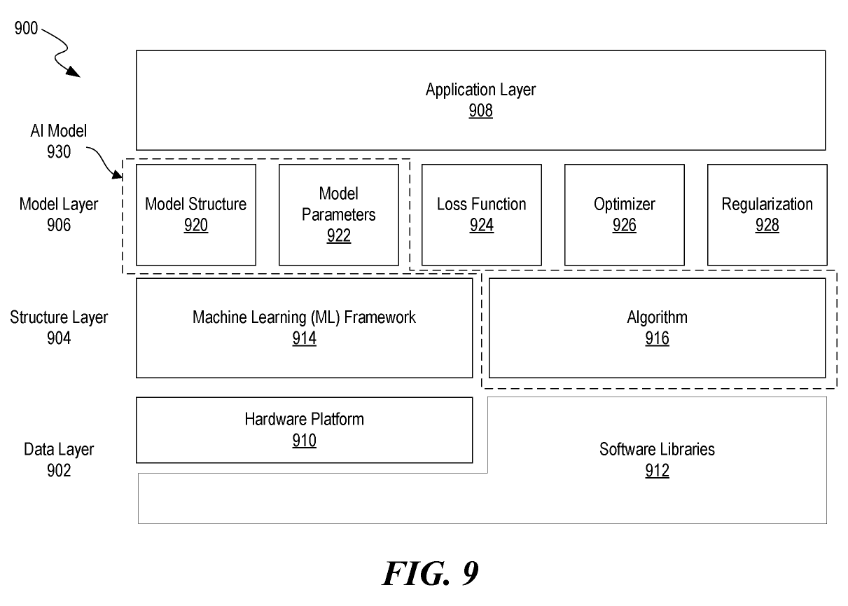

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 900 illustrated and described in more detail with reference to FIG. 9.

### Example AI Systems of the Object Provenance Platform

FIG. 9 is a high-level block diagram illustrating an example AI system, in accordance with one or more embodiments. The AI system 900 is implemented using components of the example computer system 800 illustrated and described in more detail with reference to FIG. 8. Likewise, embodiments of the AI system 900 include different and/or additional components or be connected in different ways.

In some embodiments, as shown in FIG. 9, the AI system 900 includes a set of layers, which conceptually organize elements within an example network topology for the AI system’s architecture to implement a particular AI model 930. Generally, an AI model 930 is a computer-executable program implemented by the AI system 900 that analyses data to make predictions. Information passes through each layer of the AI system 900 to generate outputs for the AI model 930. The layers include a data layer 902, a structure layer 904, a model layer 906, and an application layer 908. The algorithm 916 of the structure layer 904 and the model structure 920 and model parameters 922 of the model layer 906 together form the example AI model 930. The optimizer 926, loss function engine 924, and regularization engine 928 work to refine and optimize the AI model 930, and the data layer 902 provides resources and support for the application of the AI model 930 by the application layer 908.

The data layer 902 acts as the foundation of the AI system 900 by preparing data for the AI model 930. As shown, in some embodiments, the data layer 902 includes two sub-layers: a hardware platform 910 and one or more software libraries 912. The hardware platform 910 is designed to perform operations for the AI model 930 and includes computing resources for storage, memory, logic, and networking, such as the resources described in relation to FIG. 9. The hardware platform 910 processes amounts of data using one or more servers. The servers can perform backend operations such as matrix calculations, parallel calculations, machine learning (ML) training, and the like. Examples of servers used by the hardware platform 910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 includes Infrastructure as a Service (IaaS) resources, which are computing resources, (e.g., servers, memory, etc.) offered by a cloud services provider. In some embodiments, the hardware platform 910 includes computer memory for storing data about the AI model 930, application of the AI model 930, and training data for the AI model 930. In some embodiments, the computer memory is a form of random-access memory (RAM), such as dynamic RAM, static RAM, and non-volatile RAM.

In some embodiments, the software libraries 912 are thought of as suites of data and programming code, including executables, used to control the computing resources of the hardware platform 910. In some embodiments, the programming code includes low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource’s instruction set architecture, allowing them to run quickly with a small memory footprint. Examples of software libraries 912 that can be included in the AI system 900 include Intel Math Kernel Library, Nvidia cuDNN, Eigen, and Open BLAS.

In some embodiments, the structure layer 904 includes an ML framework 914 and an algorithm 916. The ML framework 914 can be thought of as an interface, library, or tool that allows users to build and deploy the AI model 980. In some embodiments, the ML framework 914 includes an open-source library, an application programming interface (API), a gradient-boosting library, an ensemble method, and/or a deep learning toolkit that works with the layers of the AI system facilitate development of the AI model 930. For example, the ML framework 914 distributes processes for the application or training of the AI model 930 across multiple resources in the hardware platform 910. In some embodiments, the ML framework 914 also includes a set of pre-built components that have the functionality to implement and train the AI model 930 and allow users to use pre-built functions and classes to construct and train the AI model 930. Thus, the ML framework 914 can be used to facilitate data engineering, development, hyperparameter tuning, testing, and training for the AI model 930. Examples of ML frameworks 914 that can be used in the AI system 900 include TensorFlow, PyTorch, Scikit-Learn, Keras, Caffe, LightGBM, Random Forest, and Amazon Web Services.

In some embodiments, the algorithm 916 is an organized set of computer-executable operations used to generate output data from a set of input data and can be described using pseudocode. In some embodiments, the algorithm 916 includes complex code that allows the computing resources to learn from new input data and create new/modified outputs based on what was learned. In some implementations, the algorithm 916 builds the AI model 930 through being trained while running computing resources of the hardware platform 910. The training allows the algorithm 916 to make predictions or decisions without being explicitly programmed to do so. Once trained, the algorithm 916 runs at the computing resources as part of the AI model 930 to make predictions or decisions, improve computing resource performance, or perform tasks. The algorithm 916 is trained using supervised learning, unsupervised learning, semi-supervised learning, and/or reinforcement learning.

The application layer 908 describes how the AI system 900 is used to solve problems or perform tasks. In an example implementation, the application layer 908 includes the ML framework 914.

As an example, to train an AI model 930 that is intended to model human language (also referred to as a language model), the data layer 902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 902 is annotated with ground truth labels (e.g., each data entry in the training dataset is paired with a label), or unlabeled.

Training an AI model 930 generally involves inputting into an AI model 930 (e.g., an untrained ML model) data layer 902 to be processed by the AI model 930, processing the data layer 902 using the AI model 930, collecting the output generated by the AI model 930 (e.g., based on the inputted training data), and comparing the output to a desired set of target values. If the data layer 902 is labeled, the desired target values, in some embodiments, are, e.g., the ground truth labels of the data layer 902. If the data layer 902 is unlabeled, the desired target value is, in some embodiments, a reconstructed (or otherwise processed) version of the corresponding AI model 930 input (e.g., in the case of an autoencoder) or is a measure of some target observable effect on the environment (e.g., in the case of a reinforcement learning agent). The parameters of the AI model 930 are updated based on a difference between the generated output value and the desired target value. For example, if the value outputted by the AI model 930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 930 typically is to minimize a loss function or maximize a reward function.

In some embodiments, the data layer 902 is a subset of a larger data set. For example, a data set is split into three mutually exclusive subsets: a training set, a validation (or cross-validation) set, and a testing set. The three subsets of data, in some embodiments, are used sequentially during AI model 930 training. For example, the training set is first used to train one or more ML models, each AI model 930, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model’s accuracy. Other segmentations of the larger data set and/or schemes for using the segments for training one or more ML models are possible.

Backpropagation is an algorithm for training an AI model 930. Backpropagation is used to adjust (also referred to as update) the value of the parameters in the AI model 930, with the goal of optimizing the objective function. For example, a defined loss function is calculated by forward propagation of an input to obtain an output of the AI model 930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 930 are used. The process of updating (or learning) the parameters over many iterations is referred to as training. In some embodiments, training is carried out iteratively until a convergence condition is met (e.g., a predefined maximum number of iterations has been performed, or the value outputted by the AI model 930 is sufficiently converged with the desired target value), after which the AI model 930 is considered to be sufficiently trained. The values of the learned parameters are then fixed and the AI model 930 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 930 typically involves further training the ML model on a number of data samples (which may be smaller in number/cardinality than those used to train the model initially) that closely target the specific task. For example, an AI model 930 for generating natural language that has been trained generically on publicly available text corpora is, e.g., fine-tuned by further training using specific training samples. In some embodiments, the specific training samples are used to generate language in a certain style or a certain format. For example, the AI model 930 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a LLM contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model’s theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM’s API. As described above, the prompt is processed or pre-processed into a token sequence prior to being provided as input to the LLM via the LLM’s API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as an LLM , which is a LLM based on an encoder-decoder architecture, and can simultaneously perform text generation and text understanding. The llama2 selects or trains proper pre-training corpus, pre-training targets and pre-training parameters according to different tasks and fields, and adjusts an LLM on the basis so as to improve the performance of the LLM under a specific scene.

In some embodiments, the Falcon40B is used as an LLM, which is a causal decoder-only model. During training, the model predicts the subsequent tokens with a causal language modeling task. The model applies rotational positional embeddings in the model’s transformer model and encodes the absolution positional information of the tokens into a rotation matrix.

In some embodiments, the Claude is used as an LLM, which is an autoregressive model trained on a large text corpus unsupervised.

### Additional Examples

The following examples are illustrative of several implementations of the present technology:
1. A method for determining provenance of tournament card decks of a trading card game, the method comprising:
   receiving a plurality of collectible playing cards associated with gameplay at a tournament event;
   scanning, via a card scanning apparatus, a predefined portion of each collectible playing card of the plurality of collectible playing cards during the tournament event to determine a respective digital fingerprint for each collectible playing card, wherein the respective digital fingerprint for each collectible playing card is different;
   linking the respective digital fingerprints between a subset of collectible playing cards associated with a common card deck of a plurality of card decks to generate an authenticated tournament deck set, wherein each card deck of the plurality of card decks is configured in accordance with a set of predefined game rules associated with the tournament event; and
   registering the authenticated tournament deck set in a database by associating the linked digital fingerprints of the subset of collectible playing cards from each card deck with an indication of the tournament event.
2. The method of example 1, wherein scanning the predefined portion prioritizes different portions of each collectible playing card for generating the digital fingerprint based on an estimated degree of alteration over time of each corresponding portion.
3. The method of example 1, wherein each collectible playing card includes a nameplate portion and an artwork portion, the method further comprising:
   identifying, by the card scanning apparatus, a set of reference points in the nameplate portion and the artwork portion of the collectible playing card;
   assigning, by the card scanning apparatus, a weight to each reference point, wherein a greater weight is assigned to reference points located within the nameplate portion than reference points located within a corresponding artwork portion of each collectible playing card; and
   based on the assigned weights, determine the respective digital fingerprint for each collectible playing card.
4. The method of example 1, wherein registering the authenticated tournament deck set comprises:
   obtaining a digital interface including supplemental information associated with the authenticated tournament deck set; and
   enabling access to the digital interface subsequent to scanning at least one of the subsets of collectible playing cards, wherein the digital interface is configured to display a visual representation of the respective card decks associated with the scanned subset of collectible playing cards.
5. The method of example 1, further comprising:
   generating a set of media content associated with the authenticated tournament deck set, wherein the set of media content includes at least one of: video content, audio content, an indication of a trade history, or an indication of a tournament history.
6. The method of example 1, wherein the card scanning apparatus is a first card scanning apparatus, wherein the plurality of collectible playing cards is a first plurality of collectible playing cards, further comprising:
   scanning, using a second card scanning apparatus, a second plurality of collectible playing cards to generate at least one additional authenticated tournament deck set during the tournament event, wherein the second card scanning apparatus is configured to scan the second plurality of collectible playing cards in parallel to the first card scanning apparatus scanning the first plurality of collectible playing cards.
7. The method of example 1, wherein the plurality of collectible playing cards received are associated with one or more players reaching a particular tournament placement at the tournament event.
8. A system for determining provenance of a set of objects, the system comprising:
   a computing device configured to scan a particular portion of each object of a plurality of objects to determine respective digital fingerprints of each object, wherein each digital fingerprint is unique;
   a provenance engine associated with the computing device configured to generate an authenticated object set by linking the digital fingerprints of a subset of the plurality of objects within a common object class of a plurality of object classes, wherein the subset of objects are associated with a common event; and
   a database in communication with the computing device configured to store information that associates the linked digital fingerprints of the subset of objects from each object class with an indication of the respective common event.
9. The system of example 8,
   wherein each object in the plurality of objects is a collectible playing card,
   wherein the object class indicates a tournament card deck constructed using the plurality of collectible playing cards,
   wherein the digital fingerprint of the subset of collectible playing cards within the tournament card deck includes a configuration identifier of the respective collectible playing card, and wherein the configuration identifier identifies a game format associated with the tournament card deck.
10. The system of example 8, wherein the provenance engine is configured to:
   validate a degree of participation of a user at the common event by comparing a set of scanned digital fingerprints against the linked digital fingerprints of the subset of objects of each object class.
11. The system of example 8, wherein determining the respective digital fingerprints further includes:
   obtaining media content associated with at least one object of the plurality of objects, wherein the media content includes a video of the subset of objects associated with one or more of: a trade, a signature, or a modification associated with the subset of objects;
   and associating the obtained media content with the respective digital fingerprint of the at least one object.
12. The system of example 11, wherein the media content displays a physical signing event to generate a signature portion of the at least one object.
13. The system of example 8,
   wherein the digital fingerprint indicates a particular type of each object of the plurality of object, and
   wherein the particular type of each object is determined based on an artwork portion of the object.

### CONCLUSION

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A method for determining provenance of trading cards during trading card transactions, the method comprising:
obtaining a plurality of trading cards associated with multiple trading card transactions;
contemporaneously with a trade of the plurality of trading cards, determining a respective digital fingerprint for each trading card of the plurality of trading cards by scanning a predefined portion of each trading card via a card scanning apparatus, wherein the respective digital fingerprint for each trading card is different;
based on determining the respective digital fingerprint for each trading card, linking the digital fingerprints of a subset of the plurality of trading cards in a collectible historical record indicating each trading card transaction of the multiple trading card transactions that a particular trading card was included in; and
registering the collectible historical record in a database by associating the linked digital fingerprints of the subset of trading cards from each card set with an indication of the trading card transaction.

2. The method of claim 1, further comprising:
obtaining a digital interface comprising transaction information and historical trading data associated with the collectible historical record;
enabling access to the digital interface subsequent to scanning at least one of the subset of trading cards; and
updating the historical trading data to reflect a degree of value appreciation of at least one of the subset of trading cards over multiple transactions.

3. The method of claim 1, further comprising:
generating media content associated with a particular trading card transaction, wherein the media content includes a video of the particular trading card transaction depicting a physical transfer of the at least one of the subset of trading cards between a first trading entity and a second trading entity of the particular trading card transaction; and
storing the media content in the database, wherein the database includes indications of one or more of: previous trading entities or previous transaction values of the particular trading card transaction.

4. The method of claim 1, wherein registering the collectible historical record comprises:
associating a respective linked digital fingerprint of at least one of the subset of trading cards from each card set with an owning user identifier that indicates one or more previous owners of the respective trading card.

5. The method of claim 1,
wherein scanning the predefined portion prioritizes different portions of each trading card for generating the digital fingerprint based on an estimated degree of alteration over time of each corresponding portion, and
wherein the different portions of each trading card includes one or more of: a nameplate portion indicating a name of the trading card, an artwork portion displaying visual content representative of the trading card, a symbol portion indicating a type of the trading card, a text portion indicating a set of game abilities associated with the trading card, or a resource portion indicating a set of game resources used to activate the trading card.

6. The method of claim 1, further comprising:
recording a card condition of a particular trading card across the multiple trading card transactions; and
associating an indication of the card condition of the particular trading card with a respective digital fingerprint of the particular trading card.

7. The method of claim 1, further comprising:
generating a degree of authenticity of at least one of the subset of trading cards based on respective digital fingerprints of the at least one of the subset of trading cards matching a set of predefined digital fingerprints.

8. The method of claim 1, further comprising:
identifying, via the card scanning apparatus, an observed print pattern within a predefined region of the trading card; and
determining whether the trading card is authentic based on comparing the observed print pattern against a reference print pattern corresponding to the predefined region of the trading card.

9. A method for determining provenance of collectible objects at a point of manufacture, the method comprising:
capturing, via a first camera, visual data of each collectible object of a plurality of collectible objects associated with a common manufacturing event;
identifying, based on the visual data, a particular collectible object of the plurality of collectible objects to determine a respective digital fingerprint for the particular collectible object,
wherein the respective digital fingerprint for each collectible object is different;
triggering, based on identifying the particular collectible object, a second camera configured to capture additional visual data of the particular collectible object during the common manufacturing event,
wherein the additional visual data depicts the particular collectible object in transit to packaging;
associating the additional visual data captured by the second camera with the respective digital fingerprint of the particular collectible object to generate an authenticated record for the particular collectible object; and
registering the authenticated record in a database by linking the respective digital fingerprint of the particular collectible object with an indication of the common manufacturing event.

10. The method of claim 9,
wherein the first camera is positioned overhead on a distribution line, and
wherein the visual data is captured as the plurality of collectible objects move along the distribution line.

11. The method of claim 9,
wherein the collectible object is a trading card.

12. The method of claim 9, further comprising:
scanning, via the first camera, at least one surface of the particular collectible object; and
generating the respective digital fingerprint based on scanning the at least one surface.

13. The method of claim 9, further comprising:
evaluating the visual data against one or more visual criterion; and
associating a circulation designation with the respective digital fingerprint of the particular collectible object based on whether the particular collectible object satisfies the one or more visual criterion.

14. The method of claim 9, wherein the indication of the manufacturing event includes one or more of a date of manufacture, a location of manufacture, a print run identifier, or a production identifier associated with the particular collectible object.

15. The method of claim 9, wherein the first camera and the second camera are communicatively coupled to a computing device, and wherein the computing device is configured to:
receive the visual data from the first camera; and
transmit a trigger signal to the second camera based on identifying the particular collectible object.

16. A system for determining provenance of a set of objects at a point of manufacture, the system comprising:
a first camera configured to capture visual data of each collectible object of a plurality of collectible objects during a manufacturing event;
a computing device in communication with the first camera configured to:
identify, based on the visual data, a particular collectible object of the plurality of collectible objects; and
determine a respective digital fingerprint for the particular collectible object, wherein each digital fingerprint is unique;
a second camera in communication with the computing device configured to capture additional visual data of the particular collectible object in response to the computing device identifying the particular collectible object,
wherein the additional visual data depicts the particular collectible object in transit to packaging;
a provenance engine associated with the computing device configured to generate an authenticated record by associating the additional visual data captured by the second camera with the respective digital fingerprint of the particular collectible object; and
a database coupled to the computing device configured to store information that links the respective digital fingerprint of the particular collectible object with an indication of the manufacturing event.

17. The system of claim 16,
wherein the database is further configured to store a first digital fingerprint of the particular collectible object generated prior to a modification event and a second digital fingerprint of the particular collectible object generated subsequent to the modification event, and
wherein the first digital fingerprint and the second digital fingerprint are linked to document the modification event.

18. The system of claim 16,
wherein the computing device is further configured to append a tag to the respective digital fingerprint of the particular collectible object, and
wherein the tag indicates a classification of the particular collectible object.

19. The system of claim 16, wherein the authenticated record is accessible via a mobile device subsequent to scanning the particular collectible object using the mobile device.

20. The system of claim 16, wherein the provenance engine is configured to validate authenticity of the particular collectible object by comparing the respective digital fingerprint of the particular collectible object against a new digital fingerprint associated with the particular collectible object.
